(19) United States
(12) Patent Application Publication
(10) Pub. No.: US 2002/0078453 A1
(43) Pub. Date: Jun. 20, 2002

(54) Hub pages for set top box startup screen

(76) Inventor: Hanchang Kuo, Fremont, CA (US)

Correspondence Address: MILLER PATENT SERVICES, 2500 DOCKERY LANE, RALEIGH, NC, 27606, US

(21) Appl. No.: 09/737,356

(22) Filed: Dec. 15, 2000

(51) Int. Cl. G06F 3/00; H04N 5/445; G06F 13/00; H04N 13/02; H04N 15/00

(52) U.S. Cl. 725/46; 348/47

(57) ABSTRACT

An apparatus and method of generating a customized startup page for an Electronic Programming Guide (EPG). A user establishes a user profile including preferences and location information that is stored in a database at an EPG server. Upon receipt of a request from a Set Top Box (STB) the EPG server invokes a HUB generator program that generates a custom startup page for the EPG based upon the user profile.

### FIELD OF THE INVENTION

This invention relates generally to the field of electronic programming guides (EPGs). More particularly, certain embodiments of this invention are related to an EPG with a customized startup screen.

### BACKGROUND OF THE INVENTION

Cable television (TV) systems often provide a channel that is used for displaying an electronic programming guide (EPG). The EPG provides a listing of the programs that are available on the cable system. Typically, the listing includes a plurality of time slots arranged in a column, wherein each time slot has associated with it a row of program information to thus form a grid pattern. The program information may include, for example, the name of the program, the cable channel on which the program may be found, names of actors, whether the program is broadcast in stereo, whether closed captioning is available and other associated information.

In many cable systems, a programming language such as Hypertext Markup Language (HTML) is used to format the EPG. This enables applications that are suited for viewing pages of the World Wide Web, such as web browsers that use Hypertext Transfer Protocol (HTTP), to display the EPG. Use of HTML enables the use of hyperlinks that may be selected by users to access desired Web pages. For example, users are able to shop, make purchases, conduct banking and other financial transactions, play games, conduct research and access vast amounts of information by selecting a desired hyperlink. As a result, such HTML based EPGs provide access not only to the subject matter that is available from cable systems, but also provide access to the subject matter that is available from the Web.

Unfortunately, there exists an enormous amount of content available to users of cable and satellite TV set top boxes these days, with the amount increasing constantly. It becomes difficult for the user to access only the desired content without navigation through numerous menus and pages to access the information desired. Typically, a user of a regular portal site has to surf through layers of pages to access desired information.

Through technological advancements such as fiber optics and others, the data carrying capacity, or bandwidth, of cable systems continues to rapidly increase. This enables much more information to be transmitted, from more sources, over that which was possible just a short time ago. As such, it is desirable that EPGs be provided that are capable of displaying additional information in a user configurable manner that facilitates personalized human interaction with TVs and cable systems.

### SUMMARY OF THE INVENTION

The present invention relates generally to an Electronic Programming Guide. Objects, advantages and features of the invention will become apparent to those skilled in the art upon consideration of the following detailed description of the invention.

In one embodiment of the present invention, a method of generating a customized startup page for an Electronic Programming Guide (EPG) is provided. A user establishes a user profile including preferences and location information that is stored in a database at an EPG server. Upon receipt of a request from a Set Top Box (STB) the EPG server invokes a HUB generator program that generates a custom startup page for the EPG based upon the user profile.

A method, consistent with certain embodiments of the present invention, of providing a customized startup page for an Electronic Program Guide, includes: receiving a request for the startup page from a Set Top Box associated with a user; finding a user profile corresponding to the user in a user database; generating a link to content based upon the user profile; and generating the startup page comprising at least the link to content.

An apparatus for generating an Electronic Program Guide startup Hub page for a Set Top Box, consistent with embodiments of the present invention, includes a mechanism for receiving an HTTP request from the Set Top Box. A user database stores a user profile. A Hub generating program receives the HTTP request and generates a query of the user database to retrieve the user profile from the user database. The Hub generating program generates a query of a site database for information associated with the user profile. The Hub generating program generates a Hub page by populating an HTML document with the information.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is an exemplary block diagram of an interactive cable TV system.

FIG. 2 is an exemplary block diagram of a HUB generator system consistent with the present invention.

FIG. 3 is an illustrative Electronic Programming Guide for news.

FIG. 4 is an illustrative Electronic Programming Guide for sports.

FIG. 5 is an illustrative Electronic Programming Guide for special events.

FIG. 6 is a flow chart illustrating one process of generating custom startup pages consistent with embodiments of the present invention.

FIG. 7 is a flow chart depicting one process for establishing the user's startup Hub pages consistent with embodiments of the present invention.

FIG. 8 is a flow chart illustrating one process carried out in the Hub generator program 130 for assembling a startup Hub page.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In the following description, numerous details are set forth in order to provide a thorough understanding of the present invention. However, it will be apparent to one of ordinary skill in the art that these specific details are not required in order to practice the present invention. In addition, well known electrical structures and circuits are shown in block diagram form and not described in detail in order so as to not unnecessarily obscure the present invention. Additionally, although the present invention is described in connection with an interactive cable system, it is understood that this invention is applicable to other systems wherein electronic programming guides (EPGs) are used.

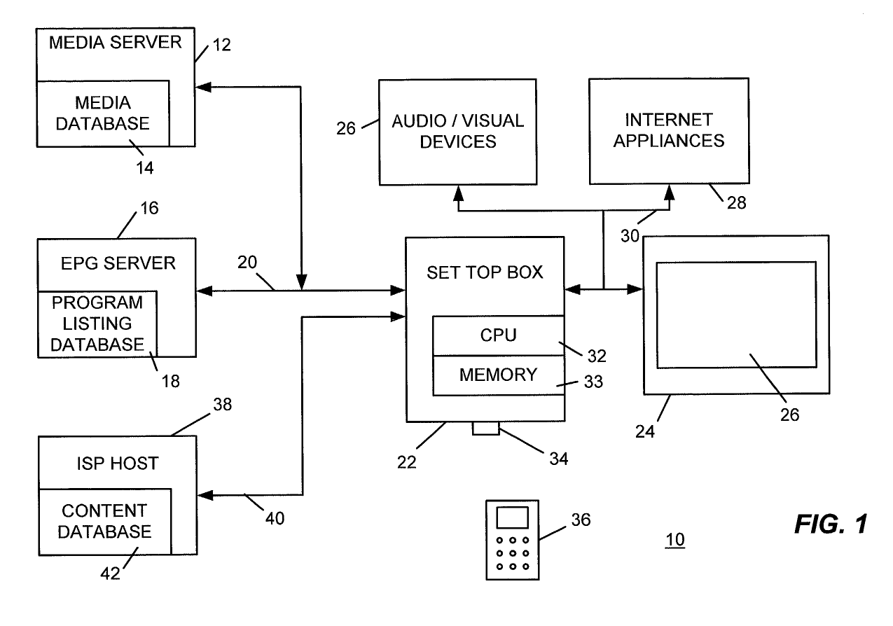

Referring to FIG. 1, a block diagram for an exemplary interactive cable television (TV) system 10 is shown. The system 10 includes a media server 12 for providing, on demand, movies and other programming obtained from a media database 14. The media server 12 might also provide additional content such as interviews with the actors, games, advertisements, available merchandise, associated Web pages, interactive games and other related content. The system 10 also includes an electronic programming guide (EPG) server 16 and a program listing database 18 for generating an EPG as will be described.

The media server 12 and EPG server 16 are coupled by a transmission medium 20 to a set top box (STB) 22. The transmission medium 20 may include a conventional coaxial cable network, a fiber optic cable network, telephone system, a satellite communication system, a radio frequency (RF) system, a microwave system, other wireless systems, a combination of wired and wireless systems or any of a variety of known electronic transmission mediums.

The exemplary system 10 further includes a TV 24, such as a digital television, having a display 26 for displaying an EPG. The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) 32 and memory 33 such as Random Access Memory (RAM), Read Only Memory (ROM), flash memory, mass storage such as a hard disc drive, or other electronic storage media, etc. Such memory and storage media is suitable for storing data as well as programmed processes for execution on the CPU 32. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be substituted for the TV 24 and STB 22.

By way of example, the STB 22 may be coupled to devices such as a personal computer, video cassette recorder, camcorder, digital camera, personal digital assistant and other audio/visual or internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. Further, the STB 22 runs an operating system suitable for a home network system such as Sony Corporation's Aperios™ real time operating system. Of course, other operating systems could also be used.

The STB 22 includes an infrared (IR) receiver 34 for receiving IR signals from an input device such as remote control 36. Alternatively, it is noted that many other communication methods may be utilized, such as wired or wireless control, radio frequency, etc. In addition, it can be readily appreciated that the input device 36 may be any device suitable for controlling the STB 22 such as a remote control, personal digital assistant, laptop computer, keyboard or computer mouse. In addition, the input device 36 may be a control panel located on the TV 24 or the STB 22.

The STB 22 may also be coupled to an independent service provider (ISP) host 38 a connection 40 to thus provide access to services on the Internet. The ISP host 38 provides various content to the user that is obtained from a content database 42. STB 22 may also be used as an Internet access device to obtain information and content from the Internet.

An EPG for depicting programming information and other content is generally accessed by selecting a hyperlink from an HTML document. A computer program which resides at the EPG server 16 then generates an EPG page including a grid table having a plurality of table cells representing programming. The server side computer programs may be implemented in C++, Open Data Base Connectivity (ODBC) and Microsoft Foundation Class (MFC) programming languages, although other suitable languages may be used. The computer program then connects to the program listing database 18 in order to associate selected TV programming information such as available programs, time slots, channel numbers, etc. with selected table cells to form an HTML based EPG having hyperlinks to more detailed programming information. The EPG can then be displayed by a Web browser which preferably supports HTML version 4.0 or higher and cascading style sheets (CSS). EPGs in use today which are based on HTML typically use an input device, such as remote control 36, to access programming through the EPG.

In accordance with the present invention, a “Hub” startup page is generated according to a user's profile including location, preferences, etc. in order to permit the user to access his or her most frequently desired programming and content. This Hub page is delivered to the user at the time of turning on the television or STB to permit immediate access to content through this custom profiled page.

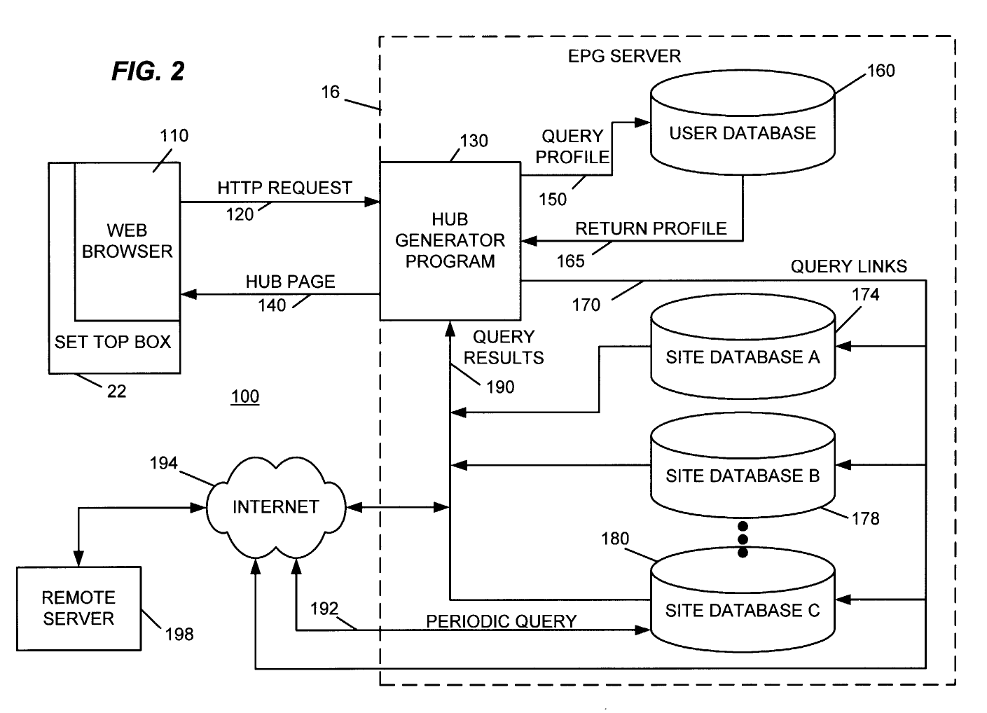

Referring now to FIG. 2, set top 22 includes a web browser 110 that sends requests, such as HTTP formatted requests 120, to a HUB generator program 130 situated on the EPG server 16. HUB generator program 130 may be, for example, written as a JAVA program. HUB generator program 130 replies to the request 120 with a HUB page (a customized HTML startup document) 140 that is displayed as a custom formatted EPG on the display 26. HUB generator program 130 generates the HUB page in accordance with a stored user profile containing information about user preferences, location, etc. The user selects what type of HUB startup page is displayed so that navigation to favorite programming and web content can be simplified. Any number of categories of startup page templates can be used (e.g. Home, Sports, News, Children, etc.) as starting points for building a custom Hub page.

When the request 120 is received by the HUB generator program 130 of EPG server 16, a query 150 is generated to identify the user profile, location, preferences, etc. for the HTTP request 120. The query 150 is processed against a user database 160 containing user preferences, which returns the information required to profile the user at 165. Query links 170 are generated as a result of the query 150 and processed against one or more site databases 174, 178 through 180 (A-C) to produce query results 190 which are returned to the HUB generator program 130. Site databases may be periodically updated as necessary in any suitable manner to provide the appropriate content or links used in generating the Hub page. For example, Site database 180 may contain weather information which is periodically updated by making periodic queries 192 through the Internet 194 (or by any other suitable connection) to a remote server 198 (e.g, a weather service site). In this example, the server may provide weather information based upon the zip code, area code, city name, etc. contained in the user profile for areas served by the EPG server 16. Moreover, the query link 170 may, in some embodiments, directly query web sites stored on remote servers such as 198 through the Internet 194 to obtain the needed information. Multiple site databases may be used to store multiple links and content associated with various types of information that may be supplied to the user through the startup page. In other embodiments, information may be periodically updated through any suitable site serving as a source of information via the Internet.

HUB generator program 130 takes the query results 190 and generates a customized HUB page 140 that is returned to the STB 22's web browser 110. This permits the user to access a customized startup HUB that provides shortcuts to the information specifically desired by the user when the television system is turned on. This process will be described in greater detail later.

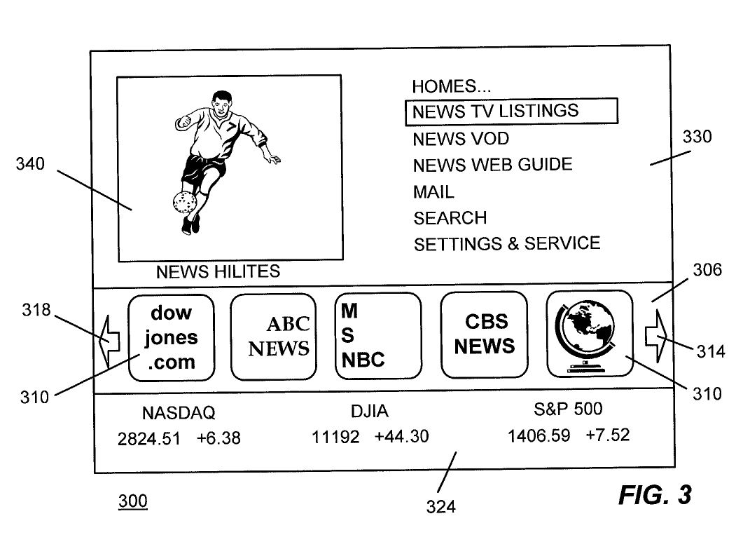

Referring now to FIG. 3, an exemplary news oriented EPG HUB 300 is illustrated. In this embodiment, a horizontally oriented grid table 306 includes a number of program cells configured as menu selection tabs (icons) 310. In this embodiment, menu selections for web sites as well as television programs are illustrated. In this embodiment, selection tabs (icons) 310 can be scrolled right or left by actuating right arrow icon 314 or left arrow icon 318 to reveal other selectable tabs 310 representing cells in the grid table. These tabs 310 represent user selected links to favorite news item locations, either being television programming, Internet web sites or other content. News items may be selected for display on the Hub page based on the type of news a viewer is particularly interested in (e.g., domestic, international, food, finance, state, local, etc.) In a lower region 324 of EPG HUB 300, stock market indices are displayed. Such indices may be updated by reference to a remote server on the Internet, for example. In certain embodiments, information such as stock market indices may be used as links to further information. Various menu selections for navigation to other pages is provided in region 330, and the current (e.g. default or most recently tuned) television channel programming appears in a live video window 340 in this embodiment. Other arrangements of similar information can also be used without departing from the invention.

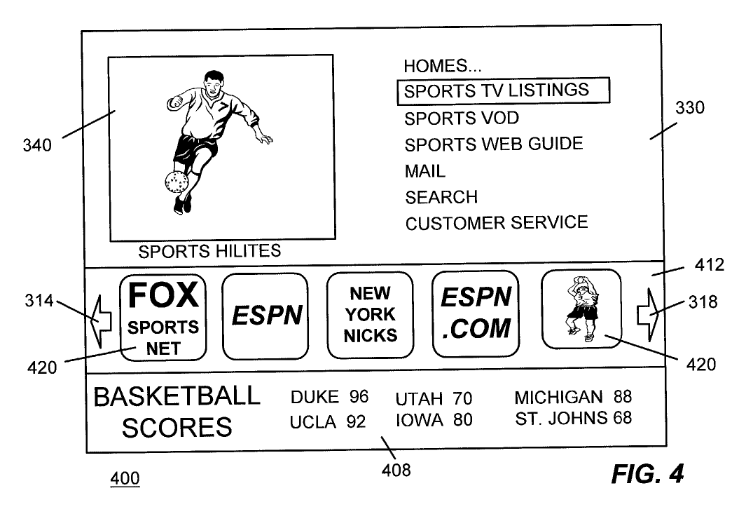

Referring to FIG. 4, sports EPG HUB 400 is shown for depicting sports information. The sports EPG HUB 400 includes a sports scores grid table 408 that depicts, for example, the final scores of college basketball games held recently for teams of interest to, and selected by the user. These scores are then retrieved from an appropriate server via the Internet, for example, to provide the user with the latest information. The sports EPG HUB 400 also includes a sports programing grid table 412 which depicts selected Web sites and programming in the form of selection tabs (icons) 420 that may be selected by the user to launch a web site or television program. Additional tabs 420 can be revealed by selection of right arrow icon 314 or left arrow icon 318 In the embodiment shown, the sports scores grid table 408 automatically scrolls vertically to reveal additional scores. Again, other menu selections are provided as 330 and live video of a favorite default program or last tuned channel is shown in live video window 340. Other arrangements are also possible.

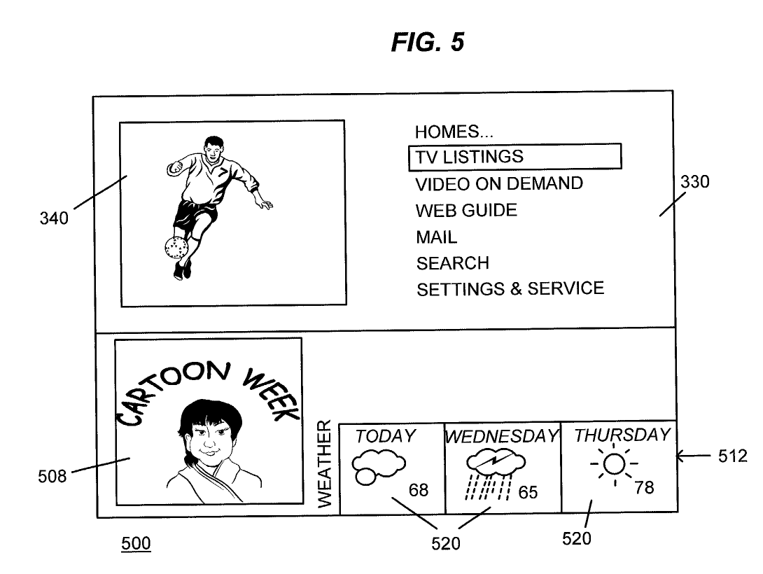

Referring to FIG. 5, another EPG HUB 500, a Home Hub, is shown for depicting an arrangement for providing information relating a user's (subscriber's) home location. By way of example, special events, special programming, and other topics of local interest can be displayed. The Home EPG HUB 500, in this example, includes an icon 508 on the EPG that depicts, for example, a link to information relating to a special event being promoted that are of interest to the user based on a user profile. Local events such as festivals, concerts, film festivals, special TV programming, etc. can be showcased in region 508. EPG HUB 500 also shows a weather grid table 512 which briefly depicts the weather forecast for the next several days. These weather forecasts may be presented in a shorthand graphical summary and may take the form of selection tabs (icons) 520 that may be selected by the user to access more detailed weather information. The weather forecast information and local interest information are based upon the user's profile location information identifying the location of the user, and can be obtained by accessing an appropriate weather server on the Internet, for example. Other arrangements are also possible.

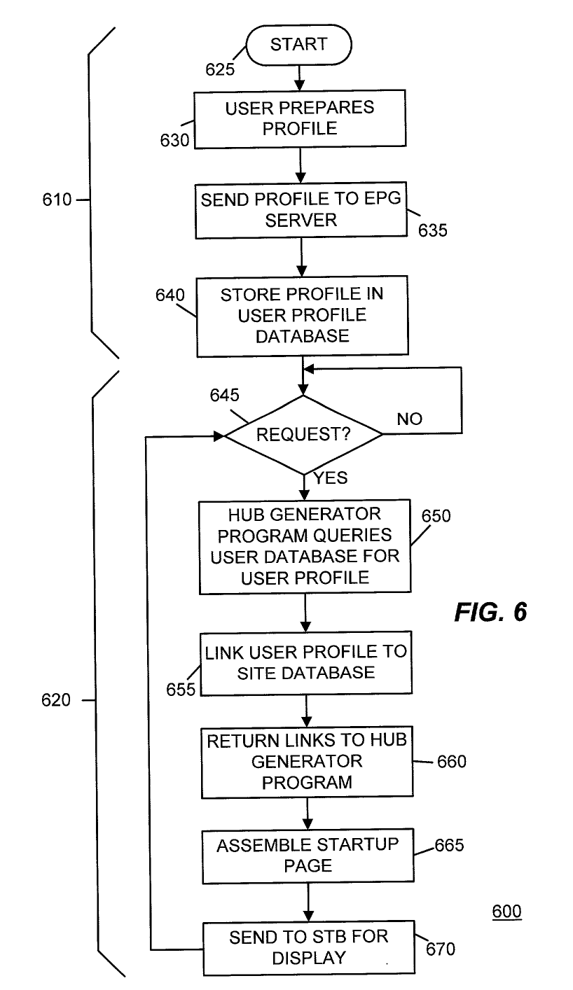

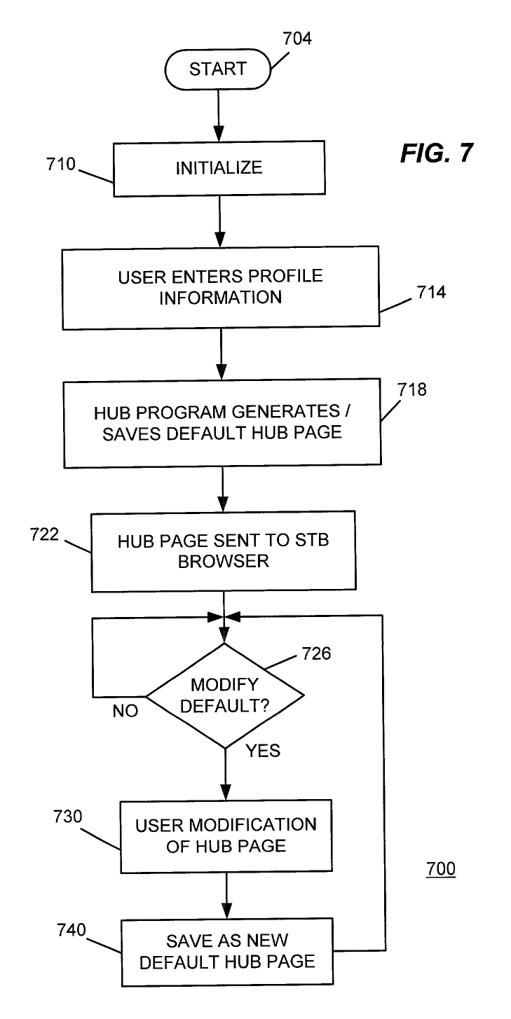

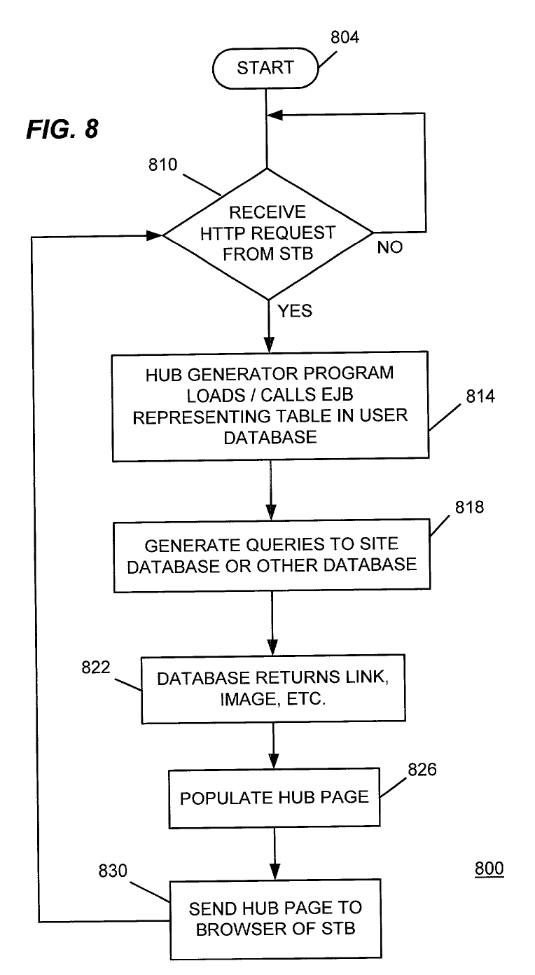

With reference to FIG. 6, the process for creating the customized HUB for use as the EPG startup page is illustrated as process 600. The process can be broken into two distinct stages. The first stage 610 describes establishing the user profile, which can be done upon initial use of the Set Top Box 22, or can be entered to reconfigure the user profile at any time the user desires. This first stage is described in greater detail in connection with FIG. 7. The second stage 620 describes generation of the startup page and is described in greater detail in connection with FIG. 8.

With reference to FIG. 6, upon first powering up the STB 22, or subsequent reset or if the user desires to change the user profile, the process starts at 625 with the user preparing a profile at 630. This can be accomplished by any suitable process such as selections from a menu, filling out form information, or providing key words, etc. The profile preferably also includes location information (which can be derived from zip code, city and state, or telephone number information in the user profile). The user profile is sent to the EPG server 16 at 635. The user profile is stored at the EPG server 16 in user database 160 until needed.

Whenever selected by the user, or upon startup of the STB 22 or television 24, the web browser 110 of the STB 22 sends HTTP request 120 to the EPG server 16. Upon detecting arrival of a request at 645, the HUB generator program 130 queries the user database 160 at 650 to obtain the profile information needed to set up the startup page. The user profile is linked to site databases such as 174, 178 and 180 as well as possibly to remote Servers containing data such as 198 via the Internet, to determine appropriate links and/or content to return as part of the startup EPG at 655. The appropriate links are returned to the HUB generator program at 660 and the HUB generator program assembles the Hub startup page at 665. This startup page is then sent, at 670, to the STB for display on display 26 and use by the user. Process 620 then awaits the next request at 645.

Referring now to FIG. 7, a process for establishing a user profile for generation of a Hub page is illustrated as 700. The process starts at 704 with initialization of the STB 22 at 710 upon initial power up of the STB 22. As a part of the initialization process, the user provides profile information at 714 as part of the registration process. This is accomplished by making selections of desired interests, default Hub page template as well as personal information (e.g. age, sex, hobbies, preferences, viewing habits, etc.) that can be used to select default content. The Hub generator program 130 generates and saves a default Hub page format at 718 based upon the user profile and the populated Hub page is sent to the Set Top Box 22's browser 110 at 722. If the user is happy with this default Hub page at 726, no action is required to keep it for future use. If, however, the user desires to modify the default page at 722, a modification process 730 is entered which allows the user to customize the page by adding or deleting links in greater detail and otherwise reconfigure the Hub page. Once the modification is complete at 730, the modified page is saved as a template for the new Hub page at 740. Many variations of this process are possible without departing from the invention.

With reference to FIG. 8, a more detailed process 800 is described for generation of the Hub page at Hub generator program 130. This process starts at 804. At 810, the process awaits a receipt of an HTTP request 120 from web browser 110 for a startup Hub page. In accordance with the preferred embodiment, when such a request is received, the Hub generator program loads an Enterprise Java Bean (EJB) at 814 representing a table in the user database 160 and calls the EJB to identify the information relating to the user's particular profile. Based upon this profile, the Hub generator program generates one or more queries 170 to local and/or remote databases at 818. The local and/or remote databases return links, images, content, etc. as required in accordance with the queries 170 at 822. This information is used to populate the stored Hub page template corresponding to the user profile at 826 to create the startup Hub page. This Hub page is then sent to the web browser 110 of STB 22 at 830 and the process returns to 810 to await the next query. Of course, many variations in this process are possible without departing from the invention.

Those skilled in the art will recognize that the present invention has been described in terms of exemplary embodiments based upon use of a set top box containing a programmed processor such as a RISC (Reduced Instruction Set Computer). However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents. The present invention is preferably implemented using a programmed processor executing programming instructions that are broadly described above in flow chart form. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent:

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing a customized startup page for an Electronic Program Guide, comprising:
receiving a request for the startup page from a Set Top Box associated with a user;
finding a user profile corresponding to the user in a user database;
generating a link to content based upon the user profile; and
generating the startup page comprising at least the link to content.

2. The method according to claim 1, wherein the content comprises a web site.

3. The method according to claim 1, wherein the content comprises a television program source.

4. The method according to claim 1, wherein the user profile comprises location information.

5. The method according to claim 1, wherein the user profile comprises programming preferences of the user.

6. The method according to claim 1, wherein the generating comprises querying a plurality of databases to obtain a plurality of links based upon the user profile.

7. The method according to claim 6, wherein at least one of the databases is accessed via the Internet.

8. The method according to claim 6, wherein at least one of the databases is updated via periodic contact with a remote server accessed via the Internet.

9. The method according to claim 1, wherein the request for the startup page from a Set Top Box is received from a web browser program residing on the Set Top Box.

10. The method according to claim 1, wherein the startup page comprises an HTML document populated with at least the link to content.

11. An apparatus for generating an Electronic Program Guide startup Hub page for a Set Top Box, comprising:
means for receiving an HTTP request from the Set Top Box;
a user database storing a user profile;
a Hub generating program that receives the HTTP request and generates a query of the user database to retrieve the user profile from the user database;
the Hub generating program generating a query of a site database for information associated with the user profile; and
the Hub generating program generating a Hub page by populating an HTML document with the information.

12. The apparatus according to claim 11, further comprising means for sending the Hub page to the Set Top Box.

13. The apparatus according to claim 11, wherein the user profile contains location information.

14. The apparatus according to claim 11, wherein the user profile contains user preferences.

15. The apparatus according to claim 11, wherein the information includes links to content selected based upon the user profile.

16. The apparatus according to claim 11, wherein the hub page comprises a template selected from a plurality of available templates based upon the user profile, and wherein the template is populated with links determined from the user profile.

17. The apparatus according to claim 11, further comprising a remote database wherein the remote database is accessed via the Internet, and wherein the Hub generating program generates a query of the remote database for information associated with the user profile.

18. The apparatus according to claim 11, wherein the site database is updated via periodic contact with a remote server accessed via the Internet.

19. The apparatus according to claim 11, wherein the HTTP request is for a startup page and is received from a web browser program residing on a Set Top Box.

20. The apparatus according to claim 11, wherein the information includes a default hub page template selected from a Home page template, a sports page template, a news page template and a children's page template.

21. An apparatus for generating an Electronic Program Guide startup Hub page for a Set Top Box, comprising:
means for receiving an HTTP request from the Set Top Box, wherein the HTTP request is for a startup page and is received from a web browser program residing on a Set Top Box;
a user database storing a user profile, wherein the user profile contains at least location information, user preferences and a default Hub page template;
wherein the default hub page template is selected from a Home page template, a sports page template, a news page template and a children's page template;
a Hub generating program that receives the HTTP request and generates a query of the user database to retrieve the user profile from the user database;
the Hub generating program generating a query of a plurality of databases for information associated with the user profile, the information comprising links to content;
the plurality of databases comprising at least a remote database wherein the remote database is accessed via the Internet, and a site database that is updated via periodic contact with a remote server accessed via the Internet;
the Hub generating program generating a Hub page by populating an HTML document with the information; and
means for sending the Hub page to the Set Top Box.
